(19) United States
(12) Patent Application Publication
(10) Pub. No.: US 2004/0192379 A1
(43) Pub. Date: Sep. 30, 2004

(54) Method and apparatus for transmitting signals of a battery-free cordless microphone

(75) Inventor: Chien-Fan Tung, TaiChung (TW)

Correspondence Address: BRUCE H. TROXELL, 5205 LEESBURG PIKE, SUITE 1404, FALLS CHURCH, VA, 22041, US

(73) Assignee: Industrial Technology Research Institute

(21) Appl. No.: 10/397,309

(22) Filed: Mar. 27, 2003

(51) Int. Cl. H04M 1/00; H04B 1/38

(52) U.S. Cl. 455/556.1; 455/550.1

(57) ABSTRACT

A battery-free cordless microphone includes a microphone part; which includes a sound receiving unit for receiving sound signal; a sampling circuit coupling to the sound receiving unit and sampling the sound signal, a modulator coupling to the sampling circuit unit and modulating the sampled sound signal with a carrier wave and obtaining an output signal, an antenna coupling to the modulator for transmitting the output signal and being to receive an electromagnetic signal, a power supply unit coupling to the previous mentioned units and inducing the electromagnetic signal to electrical power and supplying to the previous mentioned units; and a processing unit for transmitting the electromagnetic signal, receiving the output signal, de-modulating the output signal, amplifying and processing the sound signals. A signal transmitting method for a battery-free cordless microphone comprises steps of: transmitting an electromagnetic signal by the processing unit; receiving the electromagnetic signal by the antenna, inducing the electromagnetic signal to electrical power by the power supply unit, and sampling the sound signal by the microphone and conducting a sampled sound signal to the processing unit.

### FIELD OF THE INVENTION

This invention relates to an apparatus and a method of transmitting signals in a battery-free cordless microphone. More particularly, to an apparatus and a method which utilizes the radio frequency identifying tag technique to supply electrical power to the battery-free cordless microphone.

### BACKGROUND OF THE INVENTION

In the present age, cordless microphone is popular in many locations such as in lecture rooms, platforms, and karaoke houses. Because of the advancement of the wireless transmitting techniques, the sound quality of cordless microphones is much better than before. The cordless microphone is replacing the traditional microphone also because of its convenient application.

The commercial available cordless microphones can be divided into two types: the hand-held microphones and the hanging microphones. FIG. 1 illustrates the main structure of a representative hand-held microphone which includes a sound receiving unit 11 for receiving sound signals, a signal processing unit 12 for processing received sound signal, an antenna 14 for transmitting the processed sound signal, and a power supply unit 15 for supplying electrical power to these units. The power supply unit usually contains a shell and 3 or 4 serial aligned batteries FIG. 2 illustrates the main structure of a representative hanging microphone which includes a sound receiving unit 21 for receiving sound signal, a main part 22, a signal processing unit 222 for processing received sound signals, an antenna 224 for transmitting processed sound signals, a power supply unit 225 for supplying electrical power to these units, and a conducting cable 23 connecting the sound receiving unit 21 to the main part 22 for delivering electrical power to the sound receiving unit 21 and conducting the received sound signal from the sound receiving unit 21 to the main part 22. The power supply unit 225 usually contains 2 serial aligned batteries for providing electrical power. While using the hanging microphone, the main part 22 is usually hung on the belt, the conducting cable 23 usually passes through trunk, and the sound receiving unit 21 is usually clipped on the collars.

The commercial available cordless microphones usually use batteries as a source of electrical power. Therefore, the cordless microphones usually are big and heavy because of the batteries. The hanging cordless microphones separate the battery box to reduce the size of receiving unit. However, they still have disadvantages of complicate application because the conducting cable has to pass through the trunk. Another type of hanging cordless microphones utilizes Mercury batteries and no cable is required to connect the sound receiver 21 and the main part 22. Compared to the previously mentioned hanging cordless microphone, this type of hanging cordless microphone is smaller and more easily to be applied. However, the chief disadvantage of mercury batteries is that they tend to decreased power capacity greatly when the temperature is below 40 F, in addition, Mercury batteries are expensive (about 5 times the cost of an alkaline battery of equal size). Moreover, the electrical power of mercury batteries cannot last long, which results in frequent batteries replacement. The used mercury batteries may cause environment hazard. Therefore, the present invention of battery-free cordless microphone has advantages of small size and preventing the frequent replacement of batteries because no battery is required.

### SUMMARY OF THE INVENTION

The primary object of the present invention is to provide a method and an apparatus for transmitting signals of a battery-free cordless microphone.

In order to achieve above mentioned object, this invention discloses an apparatus of battery-free cordless microphone, comprising:

a microphone part, further including:

a sound receiving unit, for receiving a sound signal,

a sampling circuit coupling to said sound receiving unit, for sampling said sound signal, and

a modulator coupling to said sampling circuit, for modulating a sampled sound signal with a carrier signal and obtaining an output signal,

an antenna coupling to said modulator, for transmitting said output signal and receiving an electromagnetic signal, and

a power supply unit coupling to the previous units, for inducing said electromagnetic signal into electrical power to supply the previously mentioned circuit and units; and

a processing unit, for transmitting said electromagnetic signal, receiving said output signal, and processing said output signal including de-modulating and amplifying.

The present invention also provides a method for transmitting signals of a battery-free cordless microphone which utilizes the radio frequency identifying tag technique. The method comprises steps of:

A: transmitting an electromagnetic signal by a processing unit;

B: receiving said electromagnetic signal by an antenna of said microphone;

C: inducing said electromagnetic signal into electrical power by a power supply unit of said microphone; and

D: sampling a sound signal by said microphone and transmitting a sampled sound signal to said processing unit.

### BRIEF DESCRIPTION OF THE DRAWINGS

FIG. 1 is the structure of a hand held cordless microphone

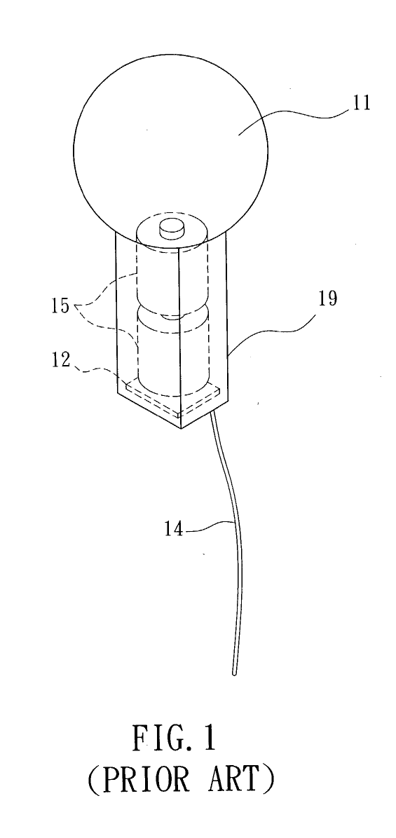

FIG. 2 is the structure of a traditional hanging type cordless microphone.

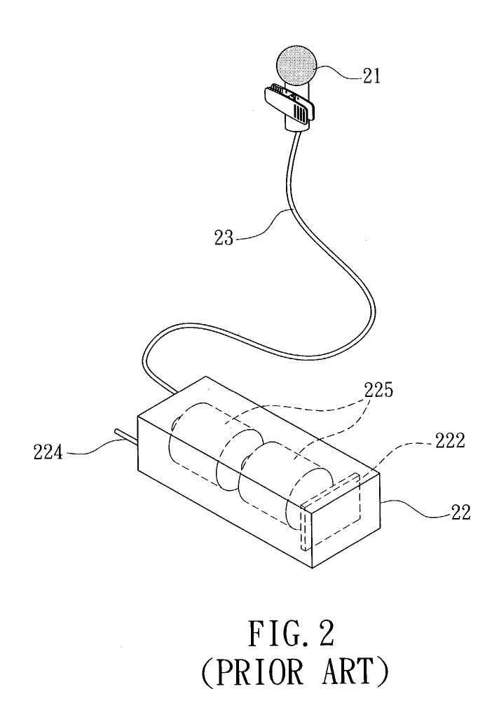

FIG. 3 is the structure of the present invented battery-free cordless microphone.

FIG. 4 is the flowchart of the steps of the present invention.

FIG. 5 is an embodiment of the present invention.

FIG. 6 is a sketch drawing illustrating a preferred embodiment of the integrated-circuit package.

### DETAILED DESCRIPTION OF THE INVENTION

This invention utilizes the radio frequency identifying tag technique to provide electrical power. The radio frequency identifying tag technique is known in the art and can be referred to the Taiwan Patent Publication No. 490640 and 424210. An example is that a sensor unit is placed at a controlled gate. This sensor unit transmits electromagnetic signals. A receiving unit is embedded in the ID card of every employer. While an employer is approaching the controlled gate, the receiving unit which embedded in the ID card receives the electromagnetic signals transmitted by the sensor unit, induces the electromagnetic signals into electrical power, and transmits the identifying information of the card holder to the sensor unit.

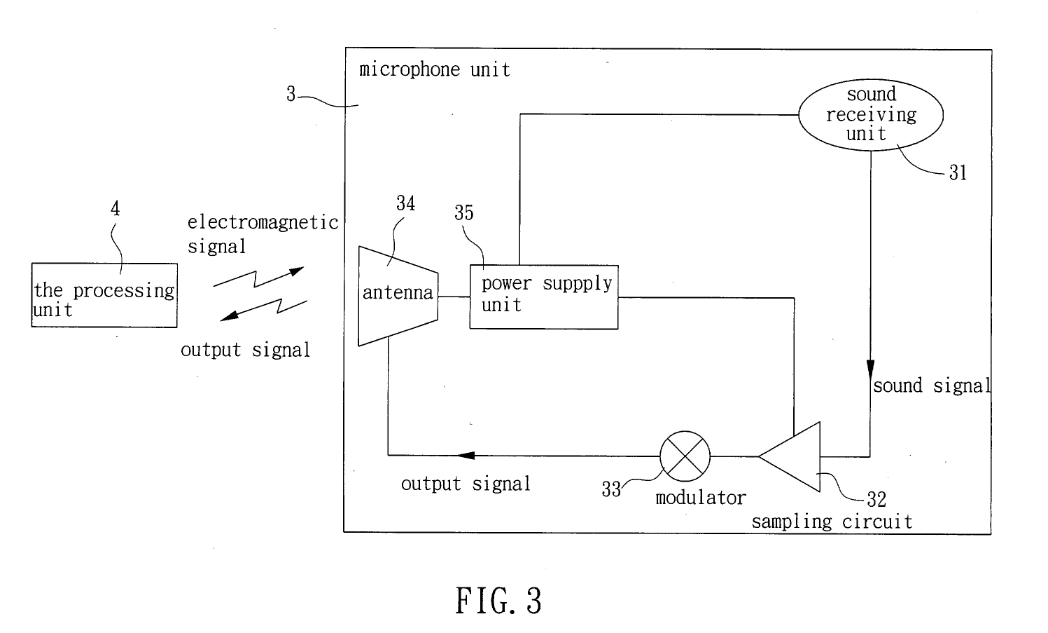

FIG. 3 illustrates the structure of this present invention. There is a microphone unit 3, a sound receiving unit 31 for receiving sound signal; a sampling circuit 32 coupling to the sound receiving unit 31 for sampling a sound signal; a modulator 33 coupling to the sampling circuit 32 for modulating the sampled sound signal with a carrier signal and obtaining an output signal; an antenna 34 coupling to the modulator 33 for transmitting the output signal and being able to receive an electromagnetic signal; a power supply unit 35 coupling to the previously mentioned circuit and units for inducing electrical power from the electromagnetic signal and delivering electrical power to the previously mentioned circuit and units, wherein, the power supply unit 35 includes a modulator 351 for converting AC to DC; a capacitor 352 for storing and supplying the DC to the previous mentioned circuit and units; and a processing unit 4, for transmitting the electromagnetic signal, receiving the output signal, and processing of the received output signal. Because the electrical power induced from an electromagnetic wave is limited, previous circuit and units must have high efficiency of utilizing the electrical power which should be formed by integrated circuits.

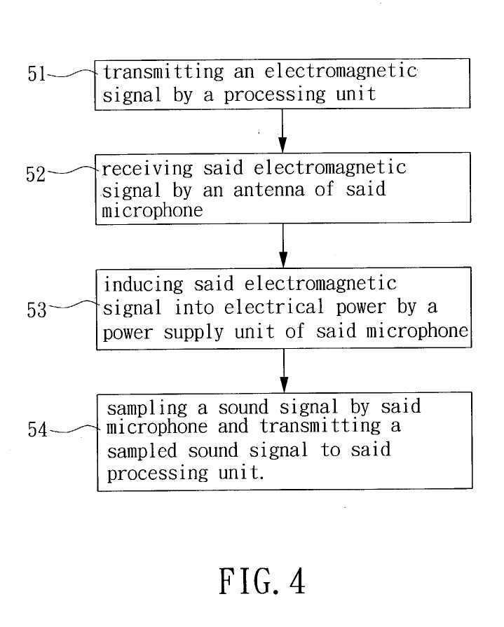

The flowchart of FIG. 4 illustrates the method of this invention, which comprises the following steps:

Step 51: Transmitting an electromagnetic signal by an antenna of a processing unit. In additions, said antenna of said processing unit is able to receive the output signal from a cordless microphone.

Step 52: Receiving the electromagnetic signal via an antenna of a cordless microphone.

Step 53: Using the power supply unit to induce electrical power from the electromagnetic signals: The electrical power induced from electromagnetic waves is usually AC. It is essential to convert AC to DC type by a rectifier in order to be utilized by other circuit and units.

Step 54: Acquiring the sound signal by the cordless microphone and transmitting to the processing unit, comprising of:

Step 541: Acquiring a sound signal;

Step 542: Sampling the sound signal;

Step 543: Modulating the sampled sound signal with a carrier wave and obtaining an output signal;

Step 544: Transmitting the output signal.

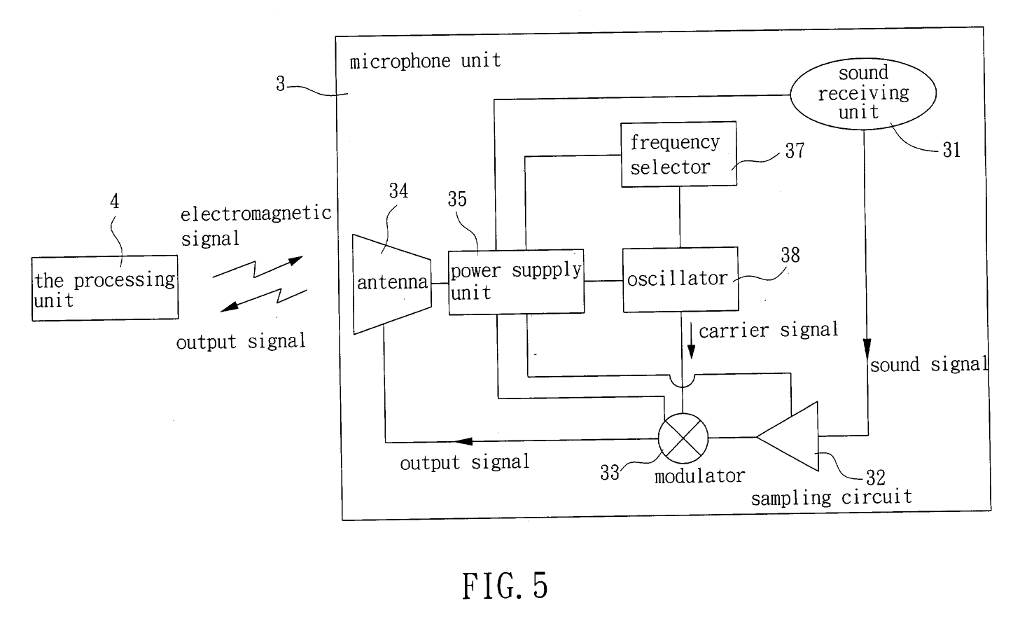

An embodiment is presented in FIG. 5. This embodiment contains previously mentions units such as a sound receiving unit 31, a sampling circuit 32, a modulator 33, an antenna 34, a power supply unit 35, and a processing unit 4. This embodiment also contains a frequency selector 37 for selecting the frequency of the carrier wave, a oscillator 38 coupling to the frequency selector 37 and modulator 33 for generating the carrier wave with the selected frequency. In the previously illustrated embodiment, the frequency of the carrier wave has to be equal to the frequency of the electromagnetic signal. In this embodiment, the frequency of the carrier wave can be different and is selected by the frequency selector 37. By using carrier waves with various frequencies, a plurality of users can use the cordless microphone at the same location.

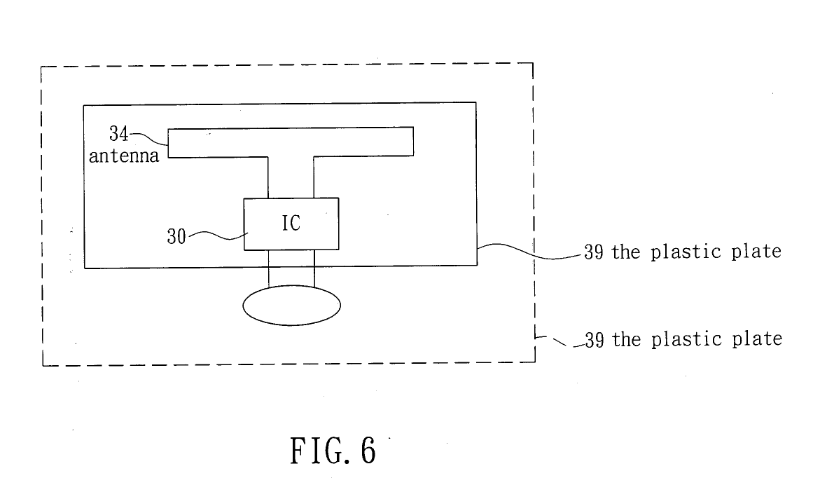

FIG. 6 is a sketch drawing illustrating a preferred embodiment of the integrated-circuit package. A plastic plate 39 supports all the units of the cordless microphone. Because the sound receiving unit 31, the sampling circuit 32, and the modulator 33 are packed in an IC 30, the total size is small. If using a capacitor type microphone, the plastic plate 39 contains only the antenna 34 and the IC 30. Total of 5*5 cm** is required. This small plastic plate can be attached on the collar. The sound receiving unit 31 and the processing unit 4 can be clipped on the shirt to acquire the sound signal which make it easy and handy to be applied. In another embodiment, the micro-electro-mechanical system (MEMS) technique us used to embedded the sound receiving unit 31 into a circuit. In this case, the required size of the plastic plate can reduced to ⅔ size of a credit card. This extremely small plastic plate 39 can be attached to any portion of the body. Therefore, the cordless microphone can be invisible in the drama performance.

While the present invention has been shown and described with reference to a preferred embodiment thereof, and in terms of the illustrative drawings, it should be not considered as limited thereby. Various possible modification, omission, and alterations could be conceived of by one skilled in the art to the form and the content of any particular embodiment, without departing from the scope and the sprit of the present invention.

What is claimed is:

1. A cordless microphone apparatus which does not require a battery, comprising:
a microphone unit which further comprising:
a sound receiving unit for receiving a sound signal;
a sampling circuit unit coupling to said sound receiving unit for sampling said sound signal to produce a sampled sound signal;
a modulator coupling to said circuit unit for modulating said sampled sound signal with a carrier signal to obtain an output signal;
an antenna coupling to said modulator for transmitting said output signal and receiving a electromagnetic signal; and
a power supply unit coupling to each of said units for transforming said electromagnetic signal in order to provide power to each of said units; and
a processing unit for emitting said electromagnetic signal, receiving said output signal, modulating said output signal and amplifying said sound signal.

2. The cordless microphone apparatus of claim 1, wherein said sampling circuit unit can filter said sampled sound signal to reduce noise.

3. The cordless microphone apparatus of claim 1,, wherein said power supply unit including:
a rectifier for converting AC electrical power into DC electrical power; and
a charger for storing said DC electrical power and supplying said DC electrical power to each of said units.

4. The cordless microphone apparatus of claim 1, further comprising:
a frequency selector for selecting a carrier frequency; and
an oscillator coupling to said frequency selector and said modulator in order to generate said carrier signal correspond to said carrier frequency.

5. The cordless microphone apparatus of claim 1, wherein the cordless microphone apparatus allows a plurality of users operating at a same location.

6. The cordless microphone apparatus of claim 1, wherein the microphone unit is composed of integrated circuits for optimal usage of electrical power.

7. A method for transmitting signals of a battery-free cordless microphone comprises steps of:
transmitting an electromagnetic signal from a processing unit;
receiving said electromagnetic signal by an antenna of said battery-free cordless microphone;
inducing said electromagnetic signal into an electrical power via a power supply unit, wherein said electrical power can be used by said battery-free cordless microphone; and
sampling a sound signal by said battery-free cordless microphone and transmitting a sampled sound signal to said processing unit.

8. The method of claim 7, wherein said power supply unit includes:
a rectifier for converting AC electrical power to DC electrical power; and
a capacitor for storing said DC electrical power and supplying said DC electrical power to each of said units.

9. The method of claim 7, wherein said transforming step further comprises steps of:
inducing said electromagnetic signal into said electrical power; and
storing said electrical power and delivering said electrical power to each of said units.

10. The method of claim 9, wherein said electrical power is a direct-current electrical power.

11. The method of claim 7, wherein said sampling and transmitting step comprises steps of:
acquiring a sound signal;
sampling said sound signal;
modulating said sampled sound signal with a carrier signal and producing an output signal; and
transmitting said output signal.

12. The method of claim 7, wherein said processing unit can receive said output signal from said battery-free cordless microphone, de-modulate and amplify said sound signal.
